(19) United States
(12) Patent Application Publication
(10) Pub. No.: US 2010/0302253 A1
(43) Pub. Date: Dec. 2, 2010

(54) REAL TIME RETARGETING OF SKELETAL DATA TO GAME AVATAR

(75) Inventors: Alex A. Kipman, Redmond, WA (US); Kudo Tsunoda, Seattle, WA (US); Jeffrey N. Margolis, Seattle, WA (US); Scott W. Sims, Atherstone (GB); Nicholas D. Burton, Hermington (GB); Andrew Wilson, Ashby de la Zouch (GB)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/548,251

(22) Filed: Aug. 26, 2009

Related U.S. Application Data
(60) Provisional application No. 61/182,505, filed on May 29, 2009.

(51) Int. Cl. G06T 13/00

(52) U.S. Cl. 345/473

(57) ABSTRACT

Techniques for generating an avatar model during the runtime of an application are herein disclosed. The avatar model can be generated from an image captured by a capture device. End-effectors can be positioned an inverse kinematics can be used to determine positions of other nodes in the avatar model.

### CROSS-REFERENCE TO RELATED APPLICATIONS

This application claims benefit under 35 U.S.C. 119(e) to U.S. Provisional Application No. 61/182,505 filed on May 29, 2009, entitled “REAL TIME RETARGETING OF SKELETAL DATA TO GAME AVATAR,” the entirety of which is incorporated herein by reference.

### BACKGROUND

Many computing applications such as computer games, multimedia applications, or the like include avatars or characters that are animated using typical motion capture techniques. For example, when developing a golf game, a professional golfer may be brought into a studio having motion capture equipment including, for example, a plurality of cameras directed toward a particular point in the studio. The professional golfer may then be outfitted in a motion capture suit having a plurality of point indicators that may be configured with and tracked by the cameras such that the cameras may capture, for example, golfing motions of the professional golfer. The motions can then applied to an avatar or character during development of the golf game. Upon completion of the golf game, the avatar or character can then be animated with the motions of the professional golfer during execution of the golf game. Unfortunately, typical motion capture techniques are costly, tied to the development of a specific application, and do not include motions associated with an actual a player or user of the application.

### SUMMARY

An example embodiment of the present disclosure describes a method. In this example, the method includes, but is not limited to receiving, during real time execution of an application, positions of avatar end-effectors, the avatar end-effectors set to positions that are calculated using positions of user end-effectors, the positions of the user end-effectors being previously generated from an image of a user; and determining, during the real time execution of the application, positions of avatar model joints to obtain an anatomically possible pose for an avatar model, the positions of the avatar model joints determined from at least the positions of the avatar end-effectors. In addition to the foregoing, other aspects are described in the claims, drawings, and text forming a part of the present disclosure.

An example embodiment of the present disclosure describes a method. In this example, the method includes, but is not limited to executing a videogame; loading an avatar model based on information received from the videogame, the avatar model including an avatar end-effector and a plurality of avatar nodes; receiving position information for a user end-effector; determining, during real time execution of the videogame, a position of an avatar end-effector, wherein the position of the avatar end-effector is calculated using the position information for the user end-effector; receiving second position information for the user end-effector; updating, during the real time execution of the videogame, the position of the avatar end-effector to a second position, wherein the position of the avatar end-effector is calculated using the second position information for the user end-effector; and determining, during the real time execution of the videogame, positions of the avatar nodes to obtain an anatomically possible pose for the avatar model, wherein the pose maintains the updated position of the avatar end-effector. In addition to the foregoing, other aspects are described in the claims, drawings, and text forming a part of the present disclosure.

An example embodiment of the present disclosure describes a method. In this example, the method includes, but is not limited to generating a user model from an image, wherein the user model includes user end-effectors; mapping, during runtime execution of an application, the user end-effectors to an avatar model; setting, during runtime execution of an application, positions of avatar joints to obtain an anatomically possible pose for the model; and modifying, during runtime execution of the application, the position of the avatar end-effectors and avatar joints based on changes to the user model. In addition to the foregoing, other aspects are described in the claims, drawings, and text forming a part of the present disclosure.

It can be appreciated by one of skill in the art that one or more various aspects of the disclosure may include but are not limited to circuitry and/or programming for effecting the herein-referenced aspects of the present disclosure; the circuitry and/or programming can be virtually any combination of hardware, software, and/or firmware configured to effect the herein-referenced aspects depending upon the design choices of the system designer.

The foregoing is a summary and thus contains, by necessity, simplifications, generalizations and omissions of detail. Those skilled in the art will appreciate that the summary is illustrative only and is not intended to be in any way limiting.

### BRIEF DESCRIPTION OF THE DRAWINGS

FIG. 1 depicts an example multimedia console wherein aspects of the present disclosure can be implemented.

FIG. 2 depicts an example computer system wherein aspects of the present disclosure can be implemented.

FIG. 3 illustrates an example embodiment of a configuration of a target recognition, analysis, and tracking system.

FIG. 4 illustrates an example embodiment of a configuration of a target recognition, analysis, and tracking system.

FIG. 5 illustrates an example embodiment of the capture device coupled to an computing environment.

FIG. 6 illustrates an example user model.

FIG. 7 illustrates an example avatar model.

FIG. 8A illustrates a user model.

FIG. 8B shows an avatar model that may have been generated from the user model.

FIG. 9 illustrates an example an avatar.

FIG. 10 depicts an operational procedure for practicing aspects of the present disclosure.

FIG. 11 depicts an alternative embodiment of the operational procedure of FIG. 10.

FIG. 12 depicts an operational procedure for practicing aspects of the present disclosure.

FIG. 13 depicts an alternative embodiment of the operational procedure of FIG. 12.

FIG. 14 an operational procedure for practicing aspects of the present disclosure.

FIG. 15 depicts an alternative embodiment of the operational procedure of FIG. 14.

### DETAILED DESCRIPTION

As will be described herein, a user may control an application executing on a computing environment such as a game console, a computer, or the like and/or may animate an avatar or on-screen character by performing one or more gestures and/or movements. According to one embodiment, the gestures and/or movements may be detected by, for example, a capture device. For example, the capture device may capture a depth image of a scene and send the image to the computing environment. A model can be generated which can be used to animate an avatar in the application.

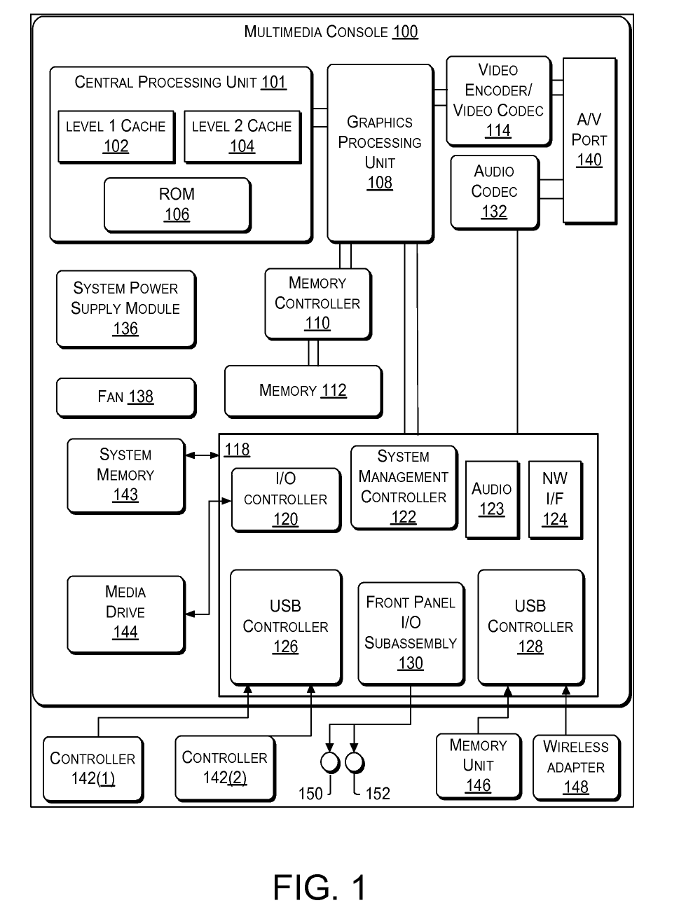

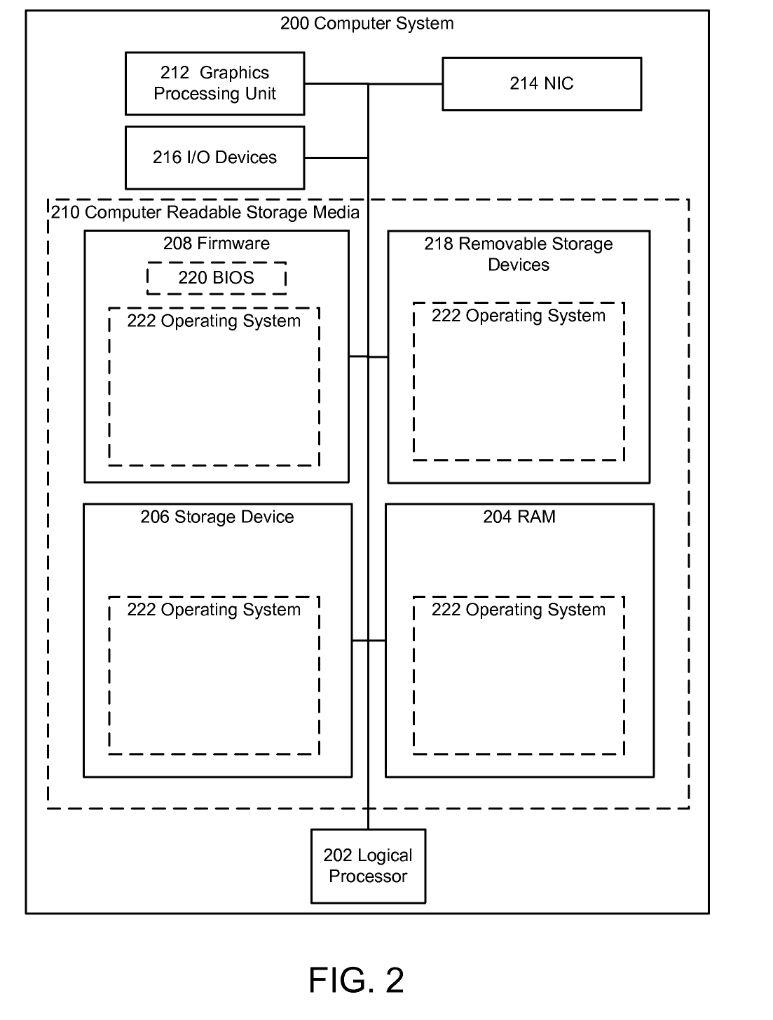

FIGS. 1 and 2 illustrate example commuting environments in which the disclosure may be implemented. One skilled in the art can appreciate that computing environment can have some or all of the components described with respect to multimedia console 100 of FIG. 1 and computer system 200 of FIG. 2.

The term circuitry used throughout the disclosure can include hardware components such as application-specific integrated circuits, hardware interrupt controllers, hard drives, network adaptors, graphics processors, hardware based video/audio codecs, and the firmware/software used to operate such hardware. The term circuitry can also include microprocessors configured to perform function(s) by firmware or by switches set in a certain way or one or more logical processors, e.g., one or more cores of a multi-core general processing unit. The logical processor(s) in this example can be configured by software instructions embodying logic operable to perform function(s) that are loaded from memory, e.g., RAM, ROM, firmware, etc. In example embodiments where circuitry includes a combination of hardware and software an implementer may write source code embodying logic that is subsequently compiled into machine readable code that can be executed by a logical processor. Since one skilled in the art can appreciate that the state of the art has evolved to a point where there is little difference between hardware, software, or a combination of hardware/software, the selection of hardware versus software to effectuate functions is merely a design choice. Thus, since one of skill in the art can appreciate that a software process can be transformed into an equivalent hardware structure, and a hardware structure can itself be transformed into an equivalent software process, the selection of a hardware implementation versus a software implementation is insignificant to this disclosure and left to an implementer.

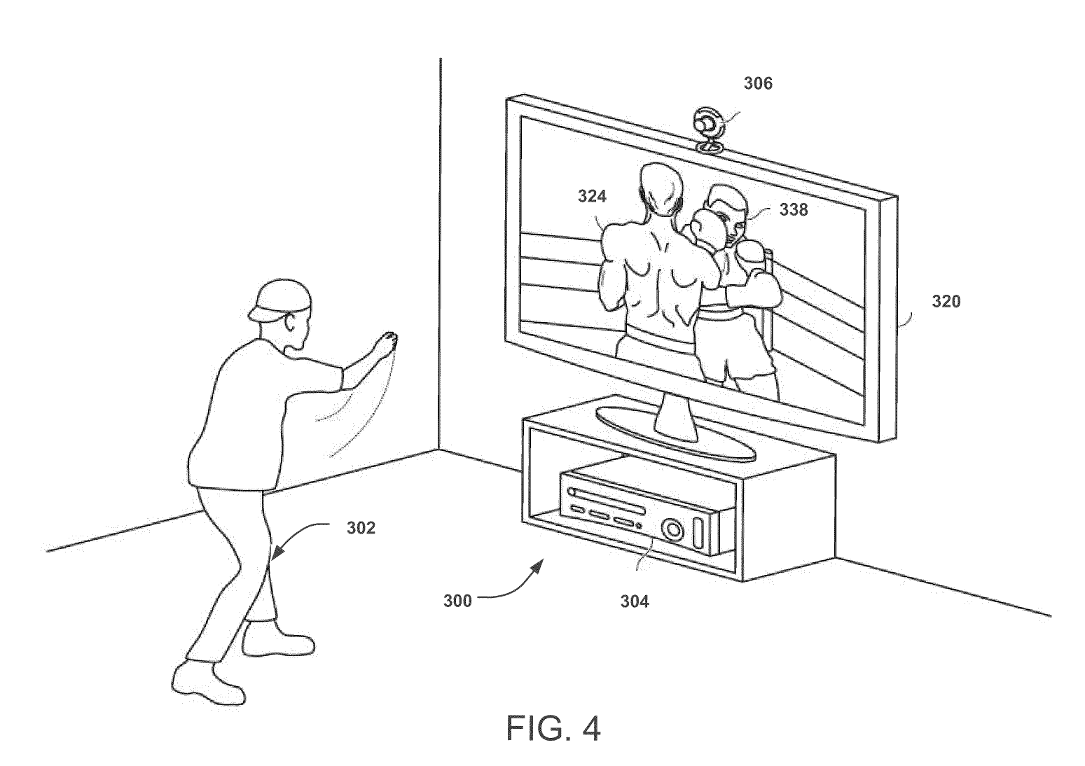

FIG. 1 illustrates an example embodiment of a computing environment that may be used to animate an avatar or on-screen character displayed by a target recognition, analysis, and tracking system of FIG. 4. The computing environment such may be a multimedia console 100, such as a gaming console. As shown in FIG. 1, the multimedia console 100 has a logical processor 101 that can have a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The logical processor 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The logical processor 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the logical processor 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the logical processor 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 26, 28 and capture device 306 may define additional input devices for the console 100.

Referring now to FIG. 2, an exemplary computing system 200 is depicted. Computer system 200 can include a logical processor 202, e.g., an execution core. While one logical processor 202 is illustrated, in other embodiments computer system 200 may have multiple logical processors, e.g., multiple execution cores per processor substrate and/or multiple processor substrates that could each have multiple execution cores. As shown by the figure, various computer readable storage media 210 can be interconnected by a system bus which couples various system components to the logical processor 202. The system bus may be any of several types of bus structures including a memory bus or memory controller, a peripheral bus, and a local bus using any of a variety of bus architectures. In example embodiments the computer readable storage media 210 can include for example, random access memory (RAM) 204, storage device 206, e.g., electromechanical hard drive, solid state hard drive, etc., firmware 208, e.g., FLASH RAM or ROM, and removable storage devices 218 such as, for example, CD-ROMs, floppy disks, DVDs, FLASH drives, external storage devices, etc. It should be appreciated by those skilled in the art that other types of computer readable storage media can be used to store data, such as magnetic cassettes, flash memory cards, digital video disks, Bernoulli cartridges, etc.

The computer readable storage media provide storage of computer readable instructions, data structures, program modules and other data for the computer 200. A basic input/output system (BIOS) 220, containing the basic routines that help to transfer information between elements within the computer system 200, such as during start up, can be stored in firmware 208. A number of applications and an operating system 222 may be stored on firmware 208, storage device 206, RAM 204, and/or removable storage devices 218, and executed by logical processor 202.

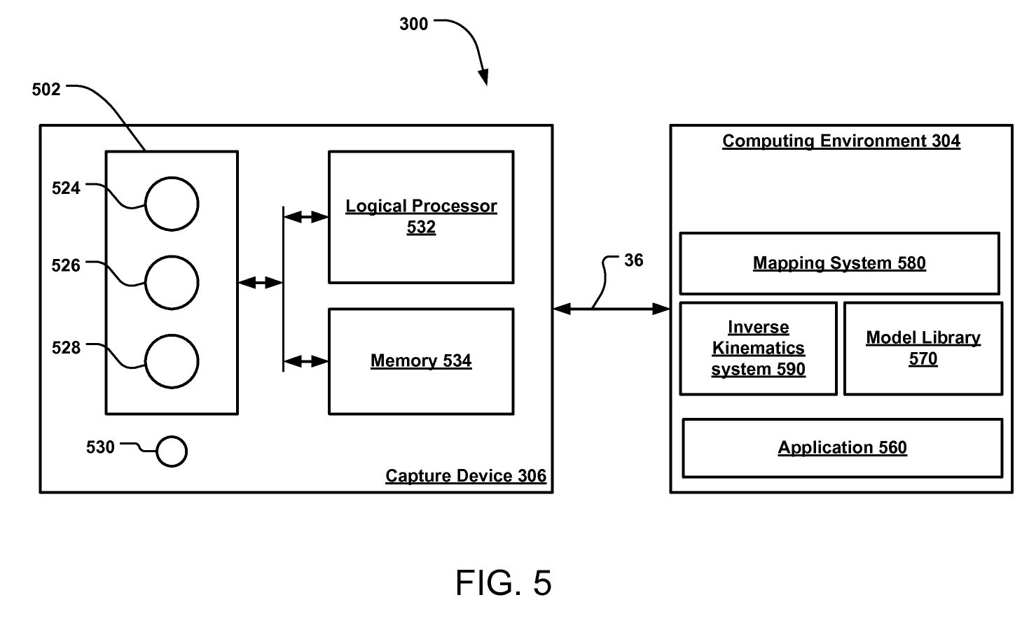

Commands and information may be received by computer 200 through input devices 216 which can include, but are not limited to, keyboards and pointing devices, joysticks, and/or the capture device 306 of FIG. 5. Other input devices may include microphones, scanners, or the like. These and other input devices are often connected to the logical processor 202 through a serial port interface that is coupled to the system bus, but may be connected by other interfaces, such as a parallel port, game port or universal serial bus (USB). A display or other type of display device can also be connected to the system bus via an interface, such as a video adapter which can be part of, or connected to, a graphics processor 212. In addition to the display, computers typically include other peripheral output devices (not shown), such as speakers and printers. The exemplary system of FIG. 1 can also include a host adapter, Small Computer System Interface (SCSI) bus, and an external storage device connected to the SCSI bus.

Computer system 200 may operate in a networked environment using logical connections to one or more remote computers, such as a remote computer. The remote computer may be another computer, a server, a router, a network PC, a peer device or other common network node, and typically can include many or all of the elements described above relative to computer system 200.

When used in a LAN or WAN networking environment, computer system 100 can be connected to the LAN or WAN through a network interface card 214 (NIC). The NIC 214, which may be internal or external, can be connected to the system bus. In a networked environment, program modules depicted relative to the computer system 100, or portions thereof, may be stored in the remote memory storage device. It will be appreciated that the network connections described here are exemplary and other means of establishing a communications link between the computers may be used. Moreover, while it is envisioned that numerous embodiments of the present disclosure are particularly well-suited for computerized systems, nothing in this document is intended to limit the disclosure to such embodiments.

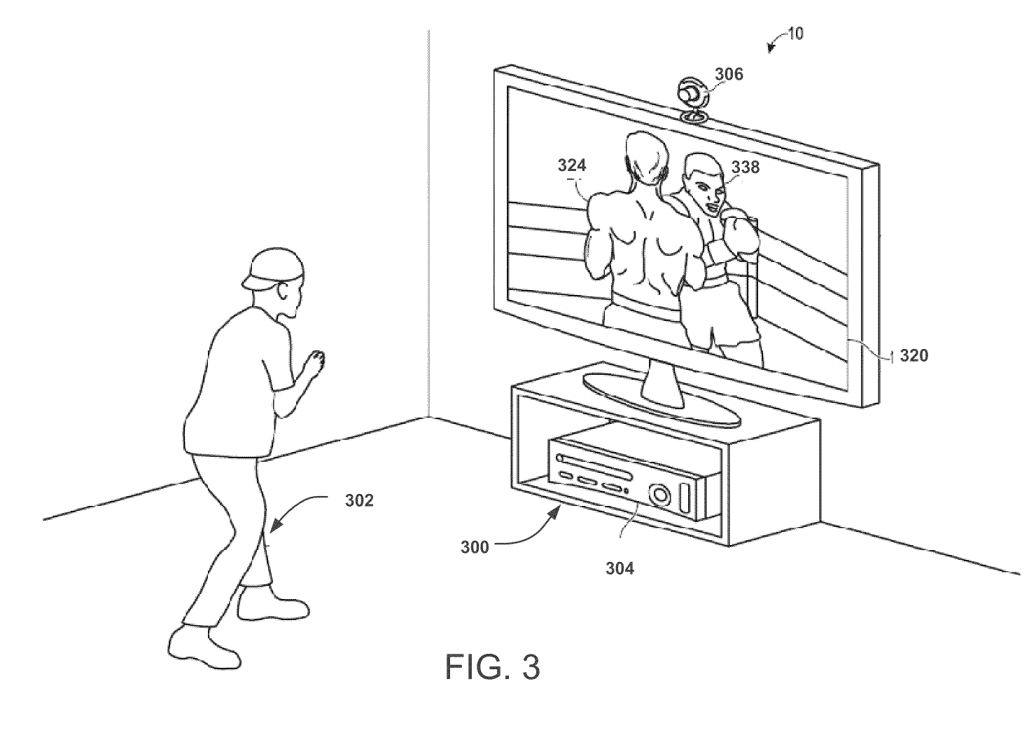

FIGS. 3 and 4 illustrate an example embodiment of a configuration of a target recognition, analysis, and tracking system 300 with a user 302 playing a boxing game. In an example embodiment, the target recognition, analysis, and tracking system 300 may be used to recognize, analyze, and/or track a human target such as the user 302.

As shown in FIG. 3, the target recognition, analysis, and tracking system 300 may include a computing environment 304. The computing environment 304 may be a computer, a gaming system or console, or the like including components similar to those described in FIGS. 1 and 2.

As shown in FIG. 3, the target recognition, analysis, and tracking system 300 may further include a capture device 306. The capture device 306 may be, for example, a camera that may be used to visually monitor one or more users, such as the user 302, such that gestures and/or movements performed by the one or more users may be captured, analyzed, and tracked to perform one or more controls or actions within an application and/or animate an avatar or on-screen character, as will be described in more detail below.

According to one embodiment, the target recognition, analysis, and tracking system 300 may be connected to an audiovisual device 320 such as a television, a monitor, a high-definition television (HDTV), or the like that may provide game or application visuals and/or audio to a user such as the user 302. For example, the computing environment 304 may include a video adapter such as a graphics card and/or an audio adapter such as a sound card that may provide audiovisual signals associated with the game application, non-game application, or the like. The audiovisual device 320 may receive the audiovisual signals from the computing environment 304 and may then output the game or application visuals and/or audio associated with the audiovisual signals to the user 302. According to one embodiment, the audiovisual device 320 may be connected to the computing environment 304 via, for example, an S-Video cable, a coaxial cable, an HDMI cable, a DVI cable, a VGA cable, or the like.

As shown in FIGS. 3 and 4, in an example embodiment, the application executing on the computing environment 304 may be a boxing game that the user 302 may be playing. For example, the computing environment 304 may use the audiovisual device 320 to provide a visual representation of a boxing opponent 338 to the user 302. The computing environment 304 may also use the audiovisual device 320 to provide a visual representation of a player avatar 324 that the user 302 may control with his or her movements. For example, as shown in FIG. 3, the user 302 may throw a punch in physical space to cause the player avatar 324 to throw a punch in game space. Thus, according to an example embodiment, the computing environment 304 and the capture device 306 of the target recognition, analysis, and tracking system 300 may be used to recognize and analyze the punch of the user 302 in physical space such that the punch may be interpreted as a game control of the player avatar 324 in game space and/or the motion of the punch may be used to animate the player avatar 324 in game space.

Other movements by the user 302 may also be interpreted as other controls or actions and/or used to animate the player avatar 324, such as controls to bob, weave, shuffle, block, jab, or throw a variety of different power punches. Furthermore, some movements may be interpreted as controls that may correspond to actions other than controlling the player avatar 324. For example, the player may use movements to end, pause, or save a game, select a level, view high scores, communicate with a friend, etc. Additionally, a full range of motion of the user 302 may be available, used, and analyzed in any suitable manner to interact with an application.

In example embodiments, the human target such as the user 302 control an avatar 324 in order to interact with objects in the application. For example, a user 302 may reach for an object in the game in order to use the object. In this example the target recognition, analysis, and tracking system 300 can be configured to allow the avatar 324 to pick up the object and use the object in the game. In a specific example, a user's avatar 324 may pick up and hold a racket used in an electronic sports game.

According to other example embodiments, the target recognition, analysis, and tracking system 300 may further be used to interpret target movements as operating system and/or application controls that are outside the realm of games. For example, virtually any controllable aspect of an operating system and/or application may be controlled by movements of the target such as the user 302.

FIG. 5 illustrates an example embodiment of the capture device 306 that may be used in the target recognition, analysis, and tracking system 300. According to an example embodiment, the capture device 306 may be configured to capture video with depth information including a depth image that may include depth values via any suitable technique including, for example, time-of-flight, structured light, stereo image, or the like. According to one embodiment, the capture device 306 may organize the depth information into “Z layers,” or layers that may be perpendicular to a Z axis extending from the depth camera along its line of sight.

As shown in FIG. 5, the capture device 306 may include an image camera component 502. According to an example embodiment, the image camera component 502 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

As shown in FIG. 5, according to an example embodiment, the image camera component 502 may include an IR light component 524, a three-dimensional (3-D) camera 526, and an RGB camera 528 that may be used to capture the depth image of a scene. For example, in time-of-flight analysis, the IR light component 524 of the capture device 306 may emit an infrared light onto the scene and may then use sensors (not shown) to detect the backscattered light from the surface of one or more targets and objects in the scene using, for example, the 3-D camera 526 and/or the RGB camera 528. In some embodiments, pulsed infrared light may be used such that the time between an outgoing light pulse and a corresponding incoming light pulse may be measured and used to determine a physical distance from the capture device 306 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device to a particular location on the targets or objects.

According to another example embodiment, time-of-flight analysis may be used to indirectly determine a physical distance from the capture device 306 to a particular location on the targets or objects by analyzing the intensity of the reflected beam of light over time via various techniques including, for example, shuttered light pulse imaging.

In another example embodiment, the capture device 306 may use a structured light to capture depth information. In such an analysis, patterned light (i.e., light displayed as a known pattern such as grid pattern or a stripe pattern) may be projected onto the scene via, for example, the IR light component 524. Upon striking the surface of one or more targets or objects in the scene, the pattern may become deformed in response. Such a deformation of the pattern may be captured by, for example, the 3-D camera 526 and/or the RGB camera 528 and may then be analyzed to determine a physical distance from the capture device to a particular location on the targets or objects.

According to another embodiment, the capture device 306 may include two or more physically separated cameras that may view a scene from different angles to obtain visual stereo data that may be resolved to generate depth information.

The capture device 306 may further include a microphone 530. The microphone 530 may include a transducer or sensor that may receive and convert sound into an electrical signal. According to one embodiment, the microphone 530 may be used to reduce feedback between the capture device 306 and the computing environment 304 in the target recognition, analysis, and tracking system 300. Additionally, the microphone 530 may be used to receive audio signals that may also be provided by the user to control applications such as game applications, non-game applications, or the like that may be executed by the computing environment 304.

In an example embodiment, the capture device 306 may further include a logical processor 532 that may be in operative communication with the image camera component 502. The capture device 306 may further include a memory component 534 that may store the instructions that may be executed by the processor 532, images or frames of images captured by the 3-D camera or RGB camera, or any other suitable information, images, or the like. According to an example embodiment, the memory component 534 may include random access memory (RAM), read only memory (ROM), cache, Flash memory, a hard disk, or any other suitable storage component. As shown in FIG. 5, in one embodiment, the memory component 534 may be a separate component in communication with the image capture component 520 and the logical processor 532. According to another embodiment, the memory component 534 may be integrated into the processor 532 and/or the image capture component 520.

The capture device 306 can be configured to obtain an image or frame of a scene captured by, for example, the 3-D camera 426 and/or the RGB camera 528 of the capture device 306. In an example embodiment the depth image may include a human target and one or more non-human targets such as a wall, a table, a monitor, or the like in the captured scene. The depth image may include a plurality of observed pixels where each observed pixel has an observed depth value associated therewith. For example, the depth image may include a two-dimensional (2-D) pixel area of the captured scene where each pixel in the 2-D pixel area may represent a depth value such as a length or distance in, for example, centimeters, millimeters, or the like of a target or object in the captured scene from the capture device. In one example embodiment, the depth image may be colorized such that different colors of the pixels of the depth image correspond to different distances of the human target and non-human targets from the capture device. For example, according to one embodiment, the pixels associated with a target closest to the capture device may be colored with shades of red and/or orange in the depth image whereas the pixels associated with a target further away may be colored with shades of green and/or blue in the depth image.

Additionally, as described above, the capture device may organize the calculated depth information including the depth image into “Z layers,” or layers that may be perpendicular to a Z axis extending from the camera along its line of sight to the viewer. The likely Z values of the Z layers may be flood filled based on the determined edges. For example, the pixels associated with the determined edges and the pixels of the area within the determined edges may be associated with each other to define a target or an object in the scene that may be compared with a pattern. As is described below, the image can be subsequently used to generate a skeletal model of the user.

Continuing with the general description of FIG. 5, the capture device 306 may be in communication with the computing environment 304 via a communication link 536. The communication link 536 may be a wired connection including, for example, a USB connection, a Firewire connection, an Ethernet cable connection, or the like and/or a wireless connection such as a wireless 802.11b, g, a, or n connection. According to an embodiment, the computing environment 304 may provide a clock to the capture device 306 that may be used to determine when to capture, for example, a scene via the communication link 536.

Additionally, the capture device 306 may provide the depth information and images captured by, for example, the 3-D camera 526 and/or the RGB camera 528, and/or a skeletal model that may be generated by the capture device 306 to the computing environment 304 via the communication link 536. The computing environment 304 may then use the model, depth information, and captured images to, for example, control an application such as a game or word processor and/or animate an avatar or on-screen character.

For example, as shown in FIG. 5, the computing environment 304 may include an application 560, a model library 570, a mapping system 580, and/or an inverse kinematics system 590. Generally, each of the elements 560-590 can be effectuated by circuitry, and while the elements 560-590 are represented as discrete elements for ease of explanation in other embodiments some or all of the functions described with respect to elements 560-590 may be performed by the same or different circuitry.

Generally, the application 560 can be a videogame or any other application that includes an avatar. In an embodiment the computing environment 304 can include a model library 570 which can store different avatars. The avatars can be animated in the application to match the motion of the user captured by the target recognition, analysis, and tracking system 300. A specific example may include a model library 570 that includes a monster character model and a series of default poses for the monster. The monster character model can be used to define how a monster looks in this specific application. The avatar can be used to generate an in-game copy of the monster having a specific pose. In one example embodiment the model library 570 can be associated with the application 560, however in other embodiments the model library 570 can be separate from the application 560 and merely used by the application 560.

Continuing with the description of FIG. 5, the mapping system 580 can be configured to map a user model that reflects the position of a user in user space to an avatar model obtained from the model library 570. For example, and as is described in more below, a user model can be generated that includes nodes. Each node in the user model can be associated with a part of the user, for example, some nodes can be joint nodes, e.g., nodes the represent a location where two or more bones interact, or appendages such as hands. Nodes can be connected by interconnects, e.g., bones, and hierarchical relationships that define a parent-child system similar to that of a tree can be established. The parent nodes may themselves be children and can be connected to other nodes. In a specific example, a wrist can be a child of an elbow, and the elbow can be a child of a shoulder. This recursive relationship can continue to one or more root nodes, which can be used as a frame of reference for mapping nodes from a user model to an avatar model. Generally, the model can include end-effectors, which are any nodes within the hierarchy that an animator wants to directly position to, for example, interact with the environment. For example, hands, feet, and heads are typical end-effectors. However an animator may desire to manipulate a shoulder, knee, or breastplate in certain situations depending on the application.

As mentioned above in an embodiment the avatar model 700 can have at least one root node and a relationship can be established using the root node of the avatar and corresponding root node (nodes) of the user model 600. The positions of the avatar nodes can be calculated from the positions of the user model nodes. For example, position information for the end-effector's parent node and grandparent node can be obtained and relationships can be established between the corresponding parent node and grandparent node.

In addition to the mapping system 580, FIG. 5 illustrates an inverse kinematics system 590. Generally, inverse kinematics is used to determine a set of positions for nodes based on the position of a given node in the hierarchical structure. For example, since the user model is generated from a marker-less system some node angles may not be received, or the avatar may have many more nodes that the user model. Thus, in an example embedment an inverse kinematics system 590 can be used. The inverse kinematics system 590 can receive end-effector positions from the mapping system 580 and can generate a pose for the avatar model that mimics at least the position of the end-effectors. In some embodiments positions other than end-effectors can be used to mimic the pose of the user model. The output of the inverse kinematics system 590 can be fed into the application 560 where it can be blended or modified with standard animations.

In an example embodiment the inverse kinematics system 590 can receive as input a set of desired end-effector position/orientation targets. From the set the inverse kinematics system 590 can provide a set of node angles that allow these targets to be met. An inverse kinematics problem is closely related to forward kinematics which can be succinctly stated by following equation:

χ=ƒ(θ) (1)

In this equation the vector of end-effector positions χ can be related to the vector of all joint angles θ through some (often complex and almost always nonlinear) function ƒ. Thus, inverse kinematics equation can be stated by the following:

θ=ƒ⁻¹(χ) (2)

From this point there are many ways in which to solve this system. In an example embodiment Jacobian based linearization techniques can be used to solve equation 2, however the disclosure is not limited to any particular way of solving an IK equation.

Generally, Jacobian IK involves linearization of the problem about the current pose of interest. For this a Jacobian matrix can be constructed as a matrix of derivatives of all end-effector dimensions with respect to all joint angles:

$$\begin{matrix}\dot{x} = J ( θ ) \dot{θ} & ( 3 ) \\ {J ( θ )}_{i , j} = \frac{\partial {x}_{i}}{\partial {θ}_{j}} & ( 4 )\end{matrix}$$

If the user model is a non-redundant character skeleton (the end-effector dimension is equivalent to the joint angle dimension, in linear algebra terms we have the same number of equations as unknowns) then the inverse kinematics system 590 can be configured to use a standard matrix inverse could to solve the IK problem:

\dot{θ}=J⁻¹(θ)\dot{χ} (5)

In some example embodiments however, the standard matrix inverse cant be used because there exists infinitely many joint angle velocities \dot{θ} which satisfy equation 5 for a given end-effector velocity \dot{χ}. In these cases a replacement matrix can be used instead of the standard matrix in order to obtain a “best” solution according to some performance criterion. In one embodiment, this criteria is least square error and Moore-Penrose pseudo-inverse (denoted with a + superscript) can be used to solve it. For example, a solution to an undermined system can be described and the sum of both a particular and a homogeneous solution, this can be represented as

\dot{θ}J⁺(θ)\dot{χ}+(1−J⁺(θ)J(θ))y (6)

Here (1−J⁺(θ)J(θ)) is the null space projection and y is an arbitrary vector that does not contribute to the end-effector velocity but allows us to make use of any redundancy in the skeleton.

In an embodiment the vector \dot{χ} can be used to control the end-effector position and the vector y is used as to drive the pose to match the source skeleton joint angles, provided they do not interfere with the end-effector positioning.

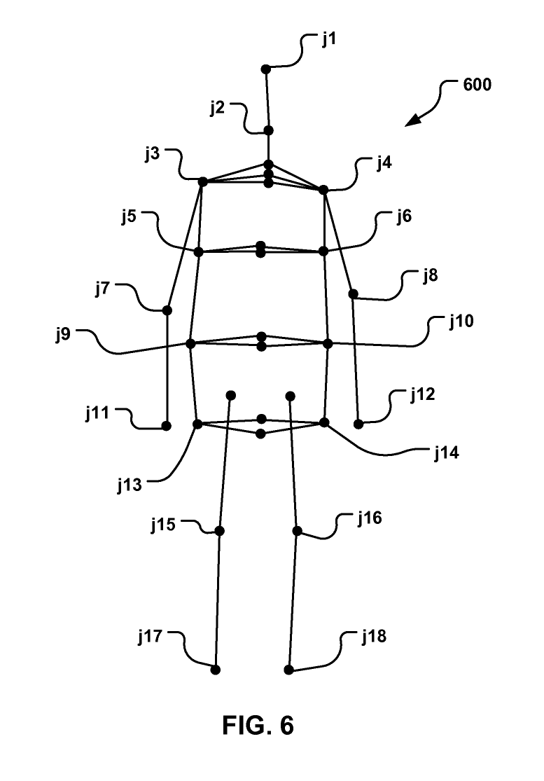

FIG. 6 illustrates a user model that can be generated by the target recognition, analysis, and tracking system 300. For example, the target recognition, analysis, and tracking system 300 can be configured to generate a model 600 from a depth image obtained by the capture device 306. In this example the target recognition, analysis, and tracking system 300 may determine whether the depth image includes a human target corresponding to, for example, a user such as the user 302, described above with respect to FIGS. 3-4, by flood filling each target or object in the depth image and comparing each flood filled target or object to a pattern associated with a body model of a human in various positions or poses. The flood filled target or object that matches the pattern may then be isolated and scanned to determine values including, for example, measurements of various body parts. According to an example embodiment, a model such as a skeletal model, a mesh model, or the like may then be generated based on the scan. For example, according to one embodiment, measurement values that may be determined by the scan may be stored in one or more data structures that may be used to define one or more joints in a model. The one or more joints may be used to define one or more bones that may correspond to a body part of a human.

Continuing with the description of FIG. 6, the model 600 may include one or more data structures that may represent, for example, a human target as a three-dimensional model. Each body part may be characterized as a mathematical vector defining nodes and interconnects of the model 600. As shown in FIG. 6, the model 600 may include one or more nodes such as joints j1-j18. According to an example embodiment, each of the joints j1-j18 may enable one or more body parts defined therebetween to move relative to one or more other body parts. For example, a model representing a human target may include a plurality of rigid and/or deformable body parts that may be defined by one or more structural members such as “bones” with the joints j1-j18 located at the intersection of adjacent bones. The joints j1-j18 may enable various body parts associated with the bones and joints j1-j18 to move independently of each other. For example, the bone defined between the joints j7 and j11, shown in FIG. 6, may correspond to a forearm that may be moved independent of, for example, the bone defined between joints j15 and j17 that may correspond to a calf.

As described above, each of the body parts may be characterized as a mathematical vector having an X value, a Y value, and a Z value defining the joints and bones shown in FIG. 6. In an example embodiment, intersection of the vectors associated with the bones, shown in FIG. 6, may define the respective point associated with joints j1-j18.

Generally, the target recognition, analysis, and tracking system 300 captures movements from the user that may be used to adjust the model. For example, a capture device such as the capture device 306 described above may capture multiple images such as depth images, RGB images, or the like of a scene that may be used to adjust the model. According to one embodiment, each of the images may be observed or captured based on a defined frequency. For example, the capture device may observe or capture a new image of a scene every millisecond, microsecond, or the like. Upon receiving each of the images, information associated with a particular image may be compared to information associated with the model to determine whether a movement may have been performed by the user. For example, in one embodiment, the model may be rasterized into a synthesized image such as a synthesized depth image. Pixels in the synthesized image may be compared to pixels associated with the human target in each of the received images to determine whether the human target in a received image has moved.

According to an example embodiment, one or more force vectors may be computed based on the pixels compared between the synthesized image and a received image. The one or more force may then be applied or mapped to one or more force-receiving aspects such as joints of the model to adjust the model into a pose that more closely corresponds to the pose of the human target or user in physical space. For example, a model may be adjusted based on movements or gestures of the user at various points observed and captured in the depth images received at various points in time as described above. In a specific example, when the user raises his or her left arm an image can be captured. The image tracking system can apply one or more force vectors or adjust the user model 600 to fit the pose of the user.

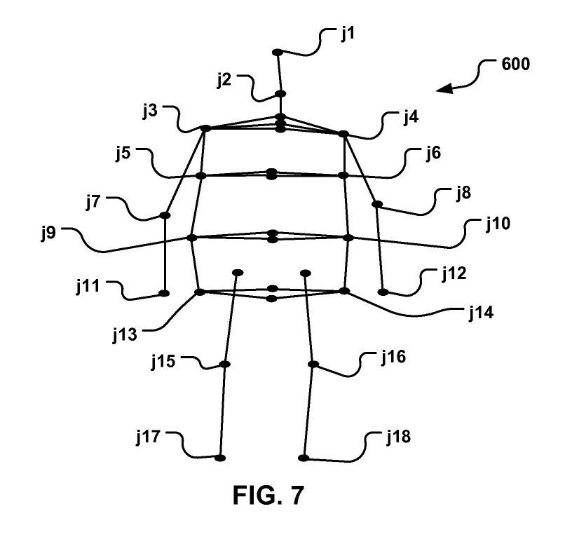

FIG. 7 illustrates an example avatar model 700 that may include one or more data structures that may represent, for example, a human target as a three-dimensional model. The avatar model 700 can be generated by the mapping system 580 by mapping nodes of the user model 600 onto nodes of the avatar model 700. In the depicted embodiment the avatar model 700 can have an architecture similar to the user model 600, however the avatar model may have a slightly different architecture or node hierarchy than the user model 600. In addition, the avatar model 700 may have more nodes than the user model or it may be larger or smaller than the user model 600. In the depicted example the avatar model is shorter and wider. Similar to that above, each body part may be characterized as a mathematical vector defining nodes and interconnects of the avatar model 700.

The mapping system 580 can be configured to receive the positions of the user nodes and remap them to the avatar nodes during the real time execution of an application 560. In an embodiment the avatar model 700 can have a root node and a relationship can made be between it and root node of a user model. For example, the model library 570 can include information that defines the relationships that are to be used at runtime. Using the relationship the position of the avatar node can be calculated from the positions of the user nodes.

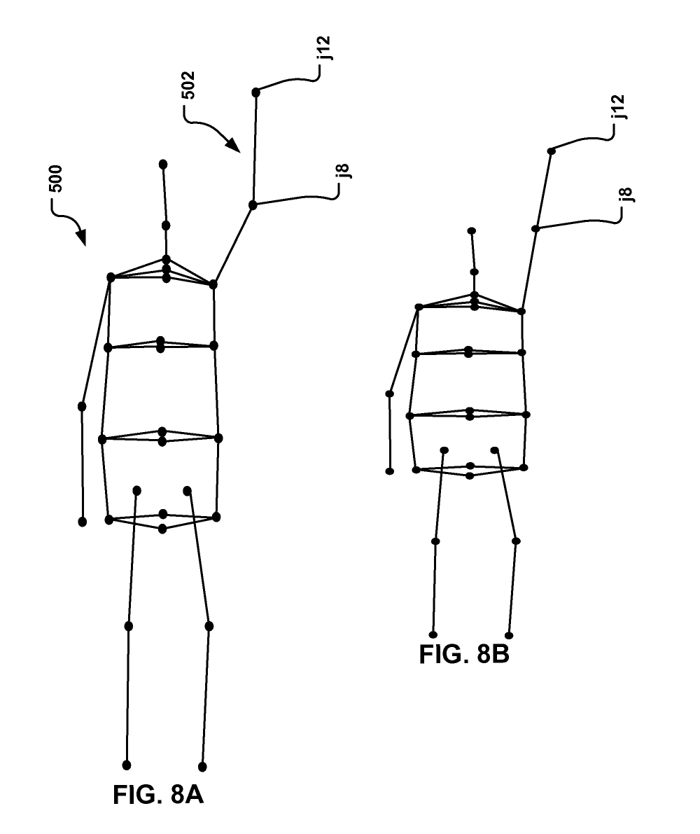

FIGS. 8A illustrates a user model 600 and FIG. 8B shows an avatar model 700 that may have been generated from the model 600. For example, In FIG. 8A a user model 600 may be generated that has his or her left arm waving. The mapping system 580 can be used to resize the user model 600 to fit, for example, the smaller avatar model 700 of FIG. 8B. In an embodiment, for example, node j12 can be an end-effector and it's position can be fed into the inverse kinematics system 590. The inverse kinematics system 590 can determine the position of j8 such that the avatar model is posed in an anatomically possible pose and still reaches the position of the end-effector. As shown by the figures, in some embodiments the pose of the avatar 700 may not match the pose of the user model 600 due to the fact that the avatar 700 is a different size. For example the arm of the avatar 700 may be straighter than the arm of the user model 600 in order to reach the position.

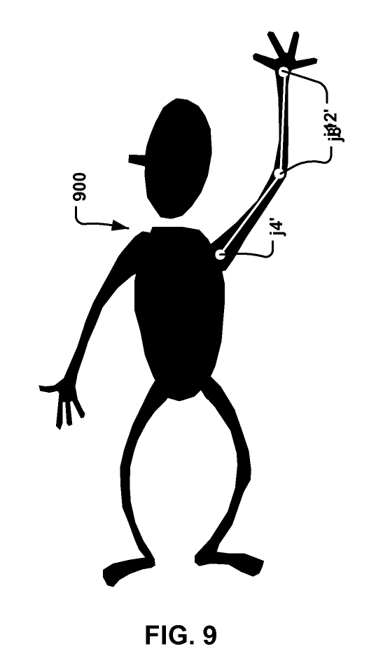

FIGS. 9 illustrates an example embodiment of an avatar or game character 900 that may be animated from the avatar model 700. As shown in FIG. 9, the avatar or game character 700 may be animated to mimic a waving motion captured for the tracked model 600 described above. For example, the joint j8, and j12 and the bones defined therebetween of the model 600 shown in FIGS. 8A and 8B may be mapped to a left elbow joint j8′ and a left wrist joint j12′. The avatar or game character 900 may then be may animated into a poses 902.

The following are a series of flowcharts depicting implementations of processes. For ease of understanding, the flowcharts are organized such that the initial flowcharts present implementations via an overall “big picture” viewpoint and subsequent flowcharts provide further additions and/or details. Furthermore, one of skill in the art can appreciate that the operational procedure depicted by dashed lines are considered optional.

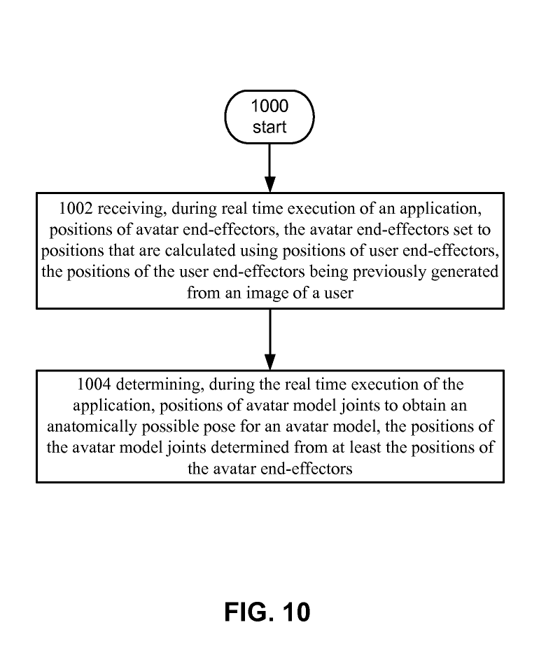

FIG. 10, it illustrates an operational procedure for practicing aspects of the present disclosure including operations 1000, 1002, and 1004. As shown by the figure, operation 1000 begins the operational procedure and operation 1002 shows receiving, during real time execution of an application, positions of avatar end-effectors, the avatar end-effectors set to positions that are calculated using positions of user end-effectors, the positions of the user end-effectors being previously generated from an image of a user. For example, and turning to FIG. 5, in an embodiment of the present disclosure the data generated from an image of the user, e.g., a user model 600, can be used to generate positions for avatar end-effectors during the execution of an application 560 such as a videogame. For example, the computing environment 304 can include a mapping system 580 that can be used to map nodes from the user model 600 to the avatar model 700 using, for example, root nodes as a point of reference. Each node in the data structure can have a position that can be, for example, an offset from its parent's, including a length value, a vertical angle, and a horizontal angle. In another embodiment each node can have geographic coordinates in space, e.g., an X value, a Y value, and a Z value. In this example embodiment the mapping system 580 can receive information that identifies the position of a user's end-effector.

In an embodiment the positions of the user end-effectors can be generated from an image stored in memory RAM, ROM of the computing environment 304. In this embodiment the capture device 306 can captured an image of the user 302 using camera component 502. The image can be used to generate a user model 600 using techniques described above.

Continuing with the description of FIG. 10, operation 1004 illustrates determining, during the real time execution of the application, positions of avatar model joints to obtain an anatomically possible pose for an avatar model, the positions of the avatar model joints determined from at least the positions of the avatar end-effectors. For example, and continuing with the example above, once the mapping system 580 obtains positions for the end-effectors in application space, the positions can be fed into the inverse kinematics system 190. The inverse kinematics system 590 can be configured to determine a pose for the avatar that takes into account the positions of the end-effectors using techniques described above.

In an embodiment the inverse kinematics system 590 can determine a pose that is anatomically possible for the model using information that define movements that can be performed by various nodes. For example a node that represents an elbow can be associated with information that defines the two movements that are possible at the node: hinge-like bending and straightening and movements that turns the forearm over. The inverse kinematics system 590 can use this information to generate positions for nodes that are valid based on this information and allow the end-effectors to reach the desired positions.

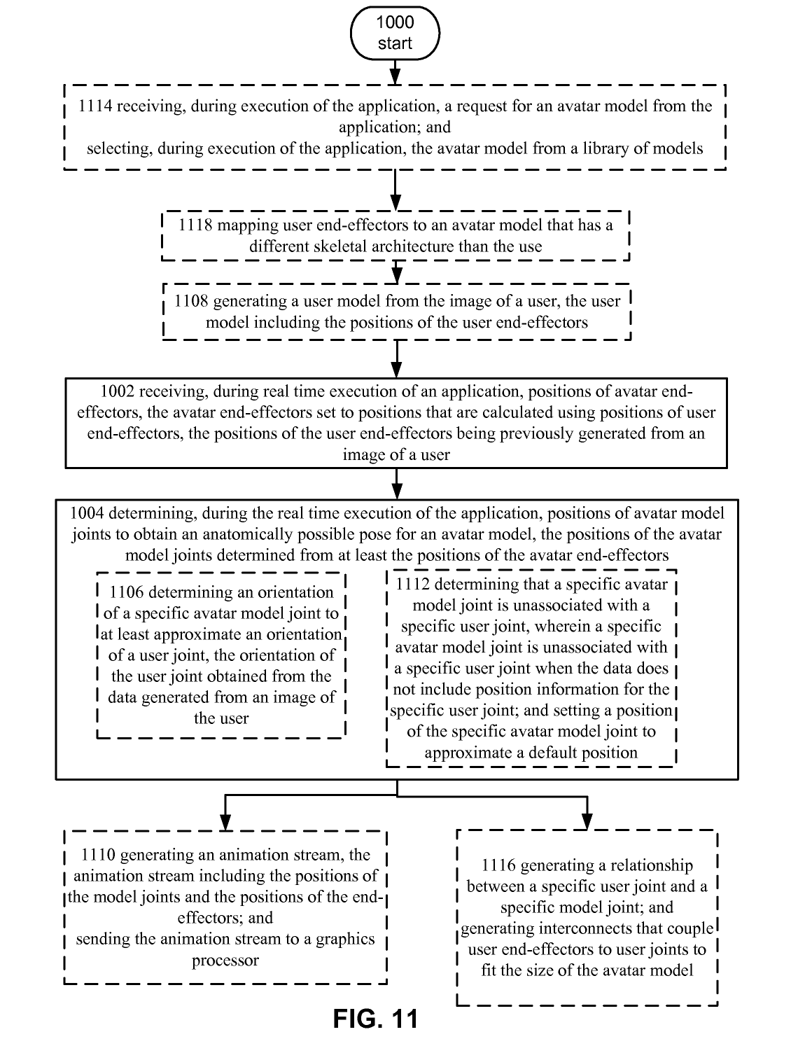

Turning now to FIG. 11, it illustrates an alternative embodiment of the operational procedure 1000 of FIG. 10 including the operations 1106-1118. Turning now to operation 1106 it shows determining an orientation of a specific avatar model joint to at least approximate an orientation of a user joint, the orientation of the user joint obtained from the data generated from an image of the user. For example, in an embodiment a user model 600 can be generated and stored in memory. In this example the user model 600 may have information that identifies positions of nodes other than end-effectors. For example, an end-effector may be a hand and the user model may have positional information for nodes that represent the user's elbow and the user's shoulder. The mapping system 580 can be executed and coordinates for these additional nodes can be transformed into positions for the avatar model 700. These positions, along with the positions of the end-effectors can then be sent to the inverse kinematics system 590. The inverse kinematics system 590 can then determine a pose for the avatar model 700 that takes into account the positional information about the other nodes. In this example the inverse kinematics system 590 can be prioritized to correctly position the end-effectors and attempt to match the orientation of any other node without having to move the end-effectors. Thus, in some example embodiments the inverse kinematics system 590 may be able to accurately place the node to mimic the orientation of the user or may position the node to approximate the orientation of the user.

Continuing with the description of FIG. 11, operation 1108 illustrates generating a user model from the image of a user, the user model including the positions of the user end-effectors. For example, in this embodiment a user model can be generated using techniques described above with respect to FIGS. 5 and 6. In this example embodiment the user model 600 can include nodes, e.g., end-effectors and multiple joints, that can be connected by interconnects, e.g., bones.

Turning to operation 1110 it illustrates generating an animation stream, the animation stream including the positions of the model joints and the positions of the end-effectors; and sending the animation stream to a graphics processor. For example, in an embodiment the avatar model 700 can be used to generate an animation stream. In this example the animation stream can be transformed into, for example, primitives and sent to a graphics processor. The graphics processor can then execute the primitives, use the avatar model to render a character in the game in memory, and then send information indicative of the rendered character to the audiovisual device 320.

Continuing with the description of FIG. 11, operation 1112 shows an embodiment where determining the positions of the avatar model joints includes, but is not limited to, determining that a specific avatar model joint is unassociated with a specific user joint, wherein a specific avatar model joint is unassociated with a specific user joint when the data does not include position information for the specific user joint; and setting a position of the specific avatar model joint to approximate a default position. For example, in an embodiment information can be stored in a model library 570 that defines default poses for the avatar models and position information for the joints in the avatar models. For example, an avatar model can be associated with information that defined the positions for joints that forms a pose similar to a “T.” The model library 570 may also include various other poses such running or walking poses or poses that show the avatar holding objects. In this example the inverse kinematics system 590 can be fed the positions of the end-effectors and the positions of any joints that were captured. The inverse kinematics system 590 can also receive information that defines default positions for joints where the system lacks position information. For example, a right knee may be a joint of interest, however a captured image may not have any information for the right knee or the information was not usable for one reason or another. In this example default position information can be used by the inverse kinematics system 590 to generate a pose for the avatar model that takes into account a default position.

In this example a default position can be selected by the mapping system 580 based on a comparison between the user model 600 and models in the model library 570. In this example information that defines the known positions of the end-effectors and any joints can be compared to the library and the default model that has the best fit can be used. The joint positions of the default can be send to the inverse kinematics system 590 for any unknown user joints.

In an example embodiment the inverse kinematics system 590 can be configured to use priority settings to determine how to pose the avatar model. For example, end-effectors can be associated with information that identifies them as the highest priority. In this case the inverse kinematics system 590 will prioritize fitting the end-effectors to the desired spots. The joints that the mapping system 580 has information about can be set to a priority level that is lower than the end-effectors. In this case, the inverse kinematics system 590 can attempt to fit these joints to positions that are at least similar to the user model joints but don't impact the positioning of the end-effectors. Finally, the joints where no information have been received can be fit. In this case the inverse kinematics system 590 will attempt to fit these joints to positions that are at least similar to default positions but don't impact the positioning of the end-effectors.

Continuing with the description of FIG. 11, operation 1114 illustrates receiving, during execution of the application, a request for an avatar model from the application; and selecting, during execution of the application, the avatar model from a library of models. For example, in an embodiment the type of model can be loaded from the model library 570 when the application is executed. In this example embodiment the application can define the type of model that is going to be used, e.g., a humanoid model, a horse model, a dragon model, etc. The mapping system 580 can receive a request that defines the type of model that is going to be used and can select the avatar model from the model library 570.

The mapping system 580 can additionally resize the avatar model based on parameters given to it from the application. For example, the model may be one size and the application may request a model that is many times larger, or smaller. In this case the application can specify the desired size and the mapping system 580 can scale the model appropriately.

Operation 1116 shows generating a relationship between a specific user joint and a specific model joint; and generating interconnects that couple user end-effectors to user joints to fit the size of the avatar model. In an embodiment the mapping system 580 can include information that maps certain joints to known joints of the model. For example, each model can have nodes that map to a user's knees, wrists, ankles, elbow, or other specific joints. Relationships can be established between these nodes and nodes of the avatar model 700. Once relationships are made interconnects, e.g., bones, can be generated to link various nodes in the model together. The mapping system 580 can obtain positions for the user model nodes and calculate positions for the avatar model nodes. The avatar model nodes can then be fed into the inverse kinematics system 590 to generate a pose for the model.

Continuing with the description of FIG. 11, operation 1118 shows mapping user end-effectors to an avatar model that has a different skeletal architecture than the user. For example, in an embodiment the model can have a different skeletal architecture than the user. In this example the avatar model may not have a humanoid skeletal architecture. For example, the avatar model can have a centaur's (mythical creature this is part human part horse) architecture. Thus, in this example the avatar model may have different bones or joints than a human. In this embodiment the mapping system 580 can including information that defines relationships between various nodes of the human and nodes of the centaur. For example, the nodes of the human's legs can be mapped to all four of the centaur's legs and the user's arms can be mapped to the centaur's arms.

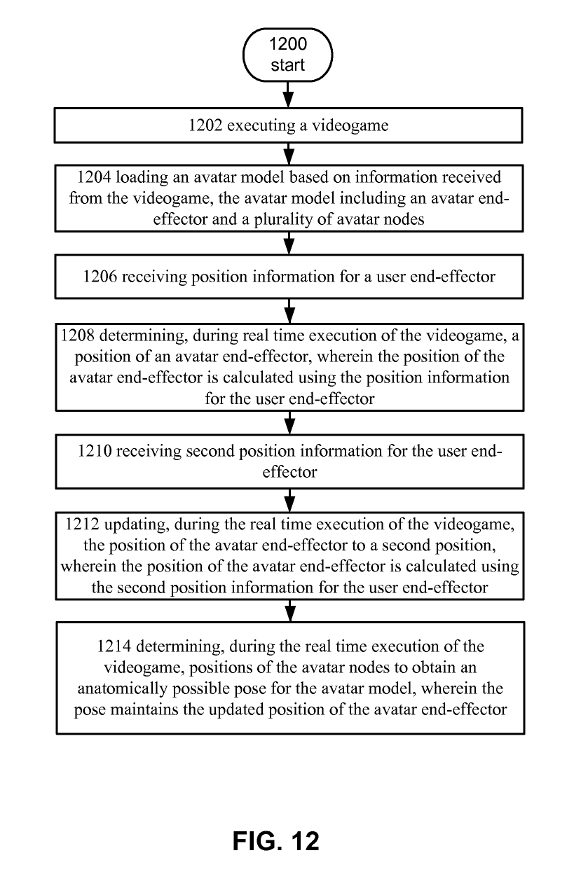

Turning to FIG. 12, it illustrates an operational procedure including operations 1200-1214. Operation 1200 begins the operational procedure and operation 1202 shows executing a videogame. For example, in an embodiment the application 160 can be a videogame. The videogame can be configured to use the target recognition, analysis, and tracking system 300 to determine how to animate an avatar in the game.

Continuing with the description of FIG. 12, operation 1204 shows loading an avatar model based on information received from the videogame, the avatar model including an avatar end-effector and a plurality of avatar nodes. For example, in an embodiment an avatar model can be loaded from the model library 570 when the videogame is executed. In this example embodiment the videogame can send a signal to the computing environment 304 that indicates what kind of avatar model it uses, e.g., a humanoid model, a horse model, a dragon model, etc. The mapping system 580 can receive the request that defines the type of model that is going to be used and can select the model from the model library 570.

The mapping system 580 can additionally resize the avatar model based on parameters given to it from the videogame. For example, the avatar model may be one size and the application may request an avatar model that is many times larger, or smaller. In this case the application can specify the desired size and the mapping system 580 can scale the model appropriately.

Continuing with the description of FIG. 12, operation 1206 shows receiving position information for a user end-effector. For example, in an embodiment the capture device 306 can capture an image of the user 302 using techniques described above and from the image a user model can be generated.

Each node in the model can have a position that can be, for example, a offset from its parent's, including a length value, a vertical angle, and a horizontal angle. In another embodiment each node can have geographic coordinates in space, e.g., an X value, a Y value, and a Z value. In this example embodiment the mapping system 580 can receive information that identifies the position of a user's end-effector that has been selected by the animator. For example, a 3-D model of the user can be stored in memory along with a coordinate system that extends from a point of reference, e.g., the root node. The position of the end-effector can be tracked and the coordinates can be stored in memory.

Continuing with the description of FIG. 12, operation 1208 determining, during real time execution of the videogame, a position of an avatar end-effector, wherein the position of the avatar end-effector is calculated using the position information for the user end-effector. For example, the mapping system 580 can be configured to receive the position of the user end-effector and remap it to the appropriate avatar end-effector during the real time execution of the videogame. For example, in an embodiment the avatar can have a root node and a relationship can be established using the root node of the avatar and the root node of a user model. Using the relationship the position of the avatar end-effector can be calculated from the position of the user end-effector. In another embodiment, the position of other nodes can be used to determine the position of the avatar end-effector. For example, position information for the end-effector's parent node and grandparent node can be obtained and relationships can be established between the corresponding parent node and grandparent node. Using the relationship the position of the avatar end-effector can be calculated from the position of the user end-effector.

Turning to operation 1210, it shows receiving second position information for the user end-effector. Some point later, e.g., 5 ms later or the speed at which the capture device can obtain a new image and an updated model can be generated, the camera can capture an image of the user 302 and mapping system 580 can receive information that identifies an updated position of a user's end-effector. For example, a 3-D model of the user can be stored in memory along with a coordinate system that extends from a point of reference, e.g., the root node. The second position of the end-effector can be tracked and the coordinates can be stored in memory.

Operation 1212 then shows updating, during the real time execution of the videogame, the position of the avatar end-effector to a second position, wherein the position of the avatar end-effector is calculated using the second position information for the user end-effector. For example, the mapping system 580 can be configured to receive the updated position of the user end-effector and update the position of the appropriate avatar end-effector during the real time execution of the videogame.

Operation 1214 shows determining, during the real time execution of the videogame, positions of the avatar nodes to obtain an anatomically possible pose for the avatar model, wherein the pose maintains the updated position of the avatar end-effector. For example, the updated position of the end-effector can be fed into the inverse kinematics system 590 and the system can determine positions of avatar nodes such as joints and/or any end-effectors that were not directly positioned by an animator. The inverse kinematics system 590 can be configured to determine a pose for the avatar model that matches the position of the avatar end-effector using techniques described above. For example a node that represents an elbow can be associated with information that defines the two movements that are possible at this node: hinge-like bending and straightening and the movement that turns the forearm over. The inverse kinematics system 590 can use this information to generate positions for nodes that are valid based on this information and still allow the end-effector to reach the desired position. Thus, the end-effect in this example will be located at the correct position, however the other nodes in the avatar model may not necessarily reflect the orientation of the user model.

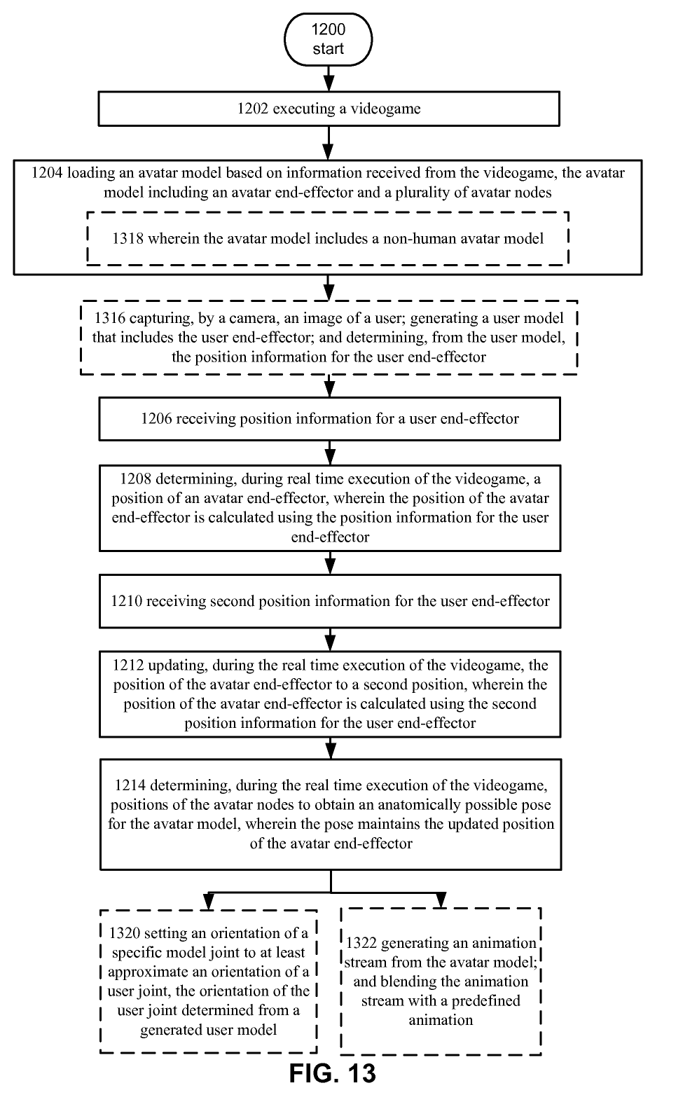

Turning now to FIG. 13, it illustrates an alternative embodiment of the operational procedure of FIG. 12 including operations 1316-1322. Operation 1316 shows capturing, by a camera, an image of a user; generating a user model that includes the user end-effector; and determining, from the user model, the position information for the user end-effector. For example, in an embodiment a capture device 306 can be used to capture the image. In this example the target recognition, analysis, and tracking system 300 can capture an image and use it to generate a user model 600. The user model 600 can be stored in memory and the mapping system 580 can be executed to determine the position of the end-effector.

Continuing with the description of FIG. 13, refinement 1318 shows that in an embodiment the avatar model includes a non-human avatar model. Similar to that described above, in an embodiment the avatar can have a non-humanoid skeletal architecture and/or a different node hierarchy, e.g., the non-humanoid architecture can include nodes that have different ranges of motion than the human counter part, or the architecture can have more or less nodes or nodes connected in a different way than in a humanoid. For example, the avatar could be a sea monster with four arms and a fin. In this example nodes on the user model 600 that represent the user's arms could be mapped to the four arms and the nodes that map to the user's legs can be mapped to the fin. In this example since the nodes of the user's legs can be mapped onto the avatar's fin in a way that makes the fin go back and forth when the user lifts his legs up and down.

Continuing with the description of FIG. 13, operation 1320 illustrates setting an orientation of a specific model joint to at least approximate an orientation of a user joint, the orientation of the user joint determined from a generated user model. For example, in an embodiment a user model can be generated and stored in memory. In this example the user model may have information that identifies a position of nodes other than end-effectors. For example, the end-effector may be a hand and the user model may have positional information for nodes that represent the user's elbow and the user's shoulder. The mapping system 580 can be executed and the coordinates for these additional nodes can be transformed into positions for the avatar.

Continuing with the description of FIG. 13, operation 1322 shows generating an animation stream from the avatar model; and blending the animation stream with a predefined animation. For example, in an embodiment the avatar model 700 can be used to generate an animation stream. An animator can add predefined animations to the animation stream in order to add additional effects to the animation. For example, a predefined animation could include a breathing animation. The animation can be blended with the avatar so that the avatar appears to be breathing when rendered. Once the animation stream is finalized, it can be transformed into, for example, primitives and sent to a graphics processor. The graphics processor can then execute the primitives, render an avatar in memory, and the rendered avatar can be sent to a monitor.

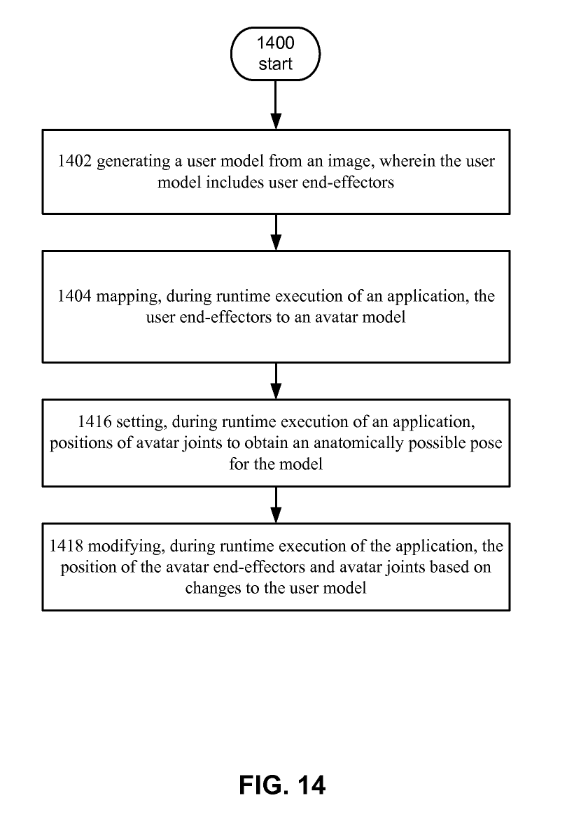

Turning now to FIG. 14, it illustrates an operational procedure including operations 1400-1410. Operation 1400 begins the procedure and operation 1402 illustrates generating a user model from an image, wherein the user model includes user end-effectors. For example, in an embodiment a target recognition, analysis, and tracking system 300 of FIG. 5 can be used to capture the image. In this example the target recognition, analysis, and tracking system 300 can capture an image and use it to generate a user model 600. The user model 600 can be stored in memory and the mapping system 580 can be executed to determine the position of the end-effectors.

Each node in the data structure can have a position that can be, for example, a offset from its parent's, including a length value, a vertical angle, and a horizontal angle. In another embodiment each node can have geographic coordinates in space, e.g., an X value, a Y value, and a Z value. In this example embodiment the mapping system 580 can receive information that identifies the position of the user's end-effectors that has been selected by the animator. For example, a 3-D model of the user can be stored in memory along with a coordinate system that extends from a point of reference, e.g., the root node. The positions of the end-effectors can be tracked and the coordinates can be stored in memory.

Continuing with the description of FIG. 14, operation 1404 shows mapping, during runtime execution of an application, the user end-effectors to an avatar model. For example, the mapping system 580 can be configured to receive the positions of the user end-effectors and remap them to the avatar end-effectors during the real time execution of an application 560. For example, in an embodiment the avatar model 700 can have a root node and a relationship can be established using the root node of the avatar and the root node of a user model. Using the relationship the position of the avatar end-effectors can be calculated from the positions of the user end-effectors similar to that described above with respect to FIGS. 5 and 6.

Continuing with the description of FIG. 14, operation 1406 shows setting, during runtime execution of an application, positions of avatar joints to obtain an anatomically possible pose for the model. For example, the positions of the end-effectors can be fed into the inverse kinematics system 590 and the system can determine positions of avatar nodes such as joints and/or any end-effectors that were not directly positioned by an animator. The inverse kinematics system 590 can be configured to determine a pose for the model that matches the positions of the avatar end-effectors using techniques described above. The inverse kinematics system 590 can use this information to generate positions for nodes that are valid based on this information and still allow the end-effectors to reach desired positions. Thus, the end-effectors in this example will be located in the correct position, however the other nodes in the avatar model may not necessarily reflect the orientation of the user model.

Continuing with the description of FIG. 14, operation 1408 illustrates modifying, during runtime execution of the application, the position of the avatar end-effectors and avatar joints based on changes to the user model. For example, the mapping system 580 can be configured to receive updated position information for the user model end-effectors and the inverse kinematics system 590 can be configured to generate updated positions for joints based on changes to the user model. In an embodiment the user model can change, for example, every 5 ms or the speed at which the capture device can obtain a new image and an updated model can be generated. In this example the execution environment 12 can be configured to modify the avatar based on the changes to the user model.

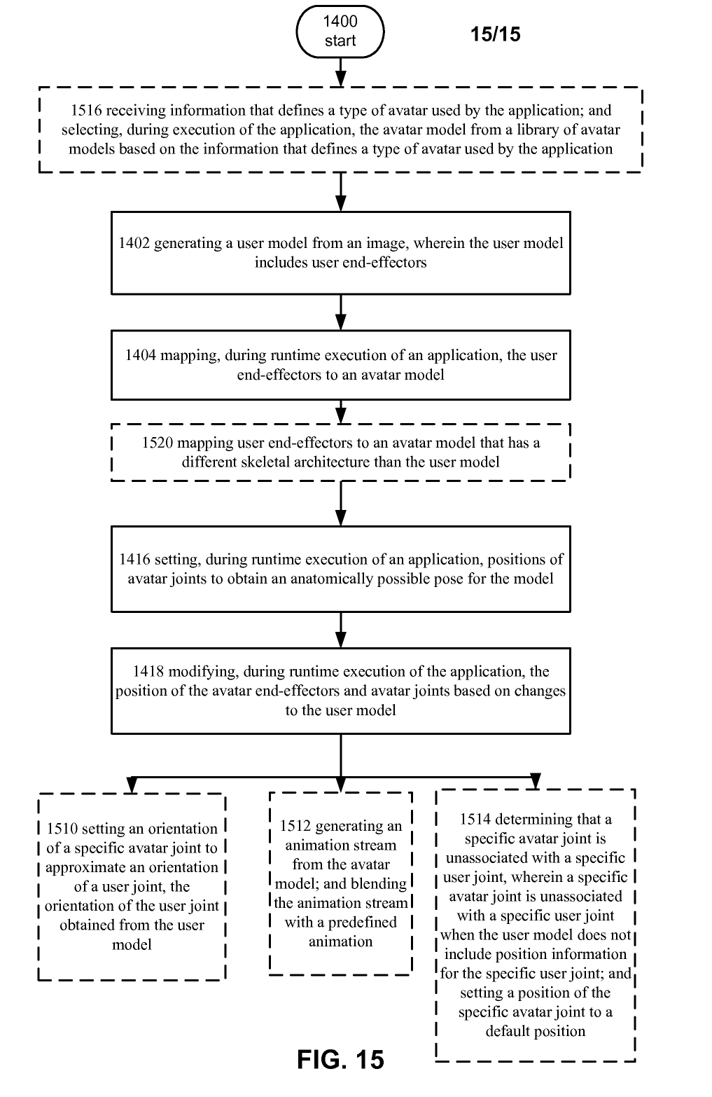

Turning now to FIG. 15, it illustrates an alternative embodiment of the operational procedure 1400 including operations 1510-1520. For example, operation 1410 shows setting an orientation of a specific avatar joint to approximate an orientation of a user joint, the orientation of the user joint obtained from the user model. For example, in an embodiment a user model can be generated and stored in memory. In this example the user model may have information that identifies a position of nodes other than end-effectors. For example, the end-effector may be a hand and the user model may have positional information for nodes that represent the user's elbow and the user's shoulder. The mapping system 580 can be executed and the coordinates for these additional nodes can be transformed into positions for the avatar model. This position, or positions, along with the position of the end-effector, can then be send to the inverse kinematics system 190. The inverse kinematics system 590 can be executed and can determine a pose for the avatar that takes into account the positional information about the other nodes. In this example the inverse kinematics system 590 can be prioritized to correctly position the end-effect and attempt to match the orientation of the node without having to move the end-effect. Thus, in some example embodiments the inverse kinematics system 590 may be able to accurately place the node or may position the node to approximate the orientation of the user.

Continuing with the description of FIG. 15, operation 1512 shows generating an animation stream from the avatar model; and blending the animation stream with a predefined animation. For example, in an embodiment the avatar model can be used to generate an animation stream. An animator can add predefined animations to the animation stream in order to add additional effects to the animation. For example, a predefined animation could include a breathing animation. The animation can be blended with the avatar model so that the avatar appears to be breathing when rendered. Once the animation stream is finalized, it can be transformed into, for example, primitives and sent to a graphics processor. The graphics processor can then execute the primitives, render an avatar in memory, and the rendered avatar can be sent to a monitor.

Turning to operation 1514, it shows determining that a specific avatar joint is unassociated with a specific user joint, wherein a specific avatar joint is unassociated with a specific user joint when the user model does not include position information for the specific user joint; and setting a position of the specific avatar joint to a default position. For example, in an embodiment information can be stored in a model library 570 that defines default poses for the avatar models and position information for the joints in the avatar models. For example, an avatar model can be associated with information that defined the positions for joints that forms a pose similar to a “T.” The model library 570 may also include various other poses such as poses running or walking or holding certain common objects. In this example the inverse kinematics system 590 can be fed the position of the end-effectors and the positions of any joints that were captured. The inverse kinematics system 590 can also receive information that defines default positions for joints where the system lacks position information. For example, a right knee may be a joint of interest, however a captured image may not have any information for the right knee or the information was not usable for one reason or another. In this example default position information can be used by the inverse kinematics system 590 to generate a pose for the model that takes into account a default position.

In this example a default position can be selected by the mapping system 580 based on a comparison between the user model 600 and models in the model library 570. In this example information that defines the known positions of the end-effectors and any joints can be compared to the library and the default model that has the best fit can be used. The joint positions of the default can be send to the inverse kinematics system 590 for any unknown user joints.

In an example embodiment the inverse kinematics system 590 can be configured to use priority settings to determine how to pose the avatar model. For example, end-effectors can be associated with information that identifies them as the highest priority. In this case the inverse kinematics system 590 will prioritize fitting the end-effectors to the desired spots. The joints that the mapping system 580 has information about can be set to a priority level that is lower than the end-effectors. In this case, the inverse kinematics system 590 can attempt to fit will not fit them if doing so would change the positions of any end-effectors. Finally, the joints where no information has been received can be fit. In this case the inverse kinematics system 590 will attempt to fit these joints but wont change the positions of any end-effectors or any joints where the system has positional information.

Continuing with the description of FIG. 15, operation 1516 shows receiving information that defines a type of avatar used by the application; and selecting, during execution of the application, the avatar model from a library of avatar models based on the information that defines a type of avatar used by the application. For example, in an embodiment the avatar model can be loaded from the model library 570 when the application is executed. In this example embodiment the application can request the model, e.g., a humanoid model, a horse model, a dragon model, etc. The mapping system 580 can receive a request that defines the type of model that is going to be used and can select the model from the model library 570.

The mapping system 580 can additionally resize the model based on parameters given to it from the application. For example, the model may be one size and the application may request a model that is many times larger, or smaller. In this case the application can specify the desired size and the mapping system 580 can scale the model appropriately.

Continuing with the description of FIG. 15, operation 1518 shows resizing interconnects that couple the user end-effectors to joints to fit the size of the avatar model. In an embodiment the mapping system 580 can include information that maps certain joints to known joints of the model. For example, each model can have nodes that map to a user's knees, wrists, ankles, elbow, or other specific joints. A relationship can be established between these nodes and nodes of the user model 600. Once relationships are made between nodes of a user model 600 and nodes in the avatar model 700 interconnects, e.g., bones, can be generated to link various nodes in the avatar 700 together. At this point the mapping system 580 can obtain positions for the user model nodes and calculate positions for the avatar model nodes. The avatar model nodes can then be fed into the inverse kinematics system 590 to generate a pose for the model.

Continuing with the description of FIG. 15, operation 1520 shows mapping user end-effectors to an avatar model that has a different skeletal architecture than the user model. Similar to that described above, in an embodiment the avatar can have a non-humanoid skeletal architecture and/or a different node hierarchy, e.g., the non-humanoid architecture can include nodes that have different ranges of motion than the human counter part, or the architecture can have more or less nodes or nodes connected in a different way than in a humanoid.

The foregoing detailed description has set forth various embodiments of the systems and/or processes via examples and/or operational diagrams. Insofar as such block diagrams, and/or examples contain one or more functions and/or operations, it will be understood by those within the art that each function and/or operation within such block diagrams, or examples can be implemented, individually and/or collectively, by a wide range of hardware, software, firmware, or virtually any combination thereof.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

What is claimed is:

1. A system, comprising:
circuitry for receiving, during real time execution of an application, positions of avatar end-effectors, the avatar end-effectors set to positions that are calculated using positions of user end-effectors, the positions of the user end-effectors being previously generated from an image of a user; and
circuitry for determining, during the real time execution of the application, positions of avatar model joints to obtain an anatomically possible pose for an avatar model, the positions of the avatar model joints determined from at least the positions of the avatar end-effectors.

2. The system of claim 1, wherein the circuitry for determining the positions of the avatar model joints further comprises:
circuitry for determining an orientation of a specific avatar model joint to at least approximate an orientation of a user joint, the orientation of the user joint obtained from the data generated from an image of the user.

3. The system of claim 1, further comprising:
circuitry for generating a user model from the image of a user, the user model including the positions of the user end-effectors.

4. The system of claim 1, further comprising:
circuitry for generating an animation stream, the animation stream including the positions of the model joints and the positions of the end-effectors; and
circuitry for sending the animation stream to a graphics processor.

5. The system of claim 1, wherein the circuitry for determining the positions of the avatar model joints further comprises:
circuitry for determining that a specific avatar model joint is unassociated with a specific user joint, wherein a specific avatar model joint is unassociated with a specific user joint when the data does not include position information for the specific user joint; and
circuitry for setting a position of the specific avatar model joint to approximate a default position.

6. The system of claim 1, further comprising:
circuitry for receiving, during execution of the application, a request for an avatar model from the application; and
circuitry for selecting, during execution of the application, the avatar model from a library of models.

7. The system of claim 1, further comprising:
circuitry for generating a relationship between a specific user joint and a specific model joint; and
circuitry for generating interconnects that couple user end-effectors to user joints to fit the size of the avatar model.

8. The system of claim 1, further comprising:
circuitry for mapping user end-effectors to an avatar model that has a different skeletal architecture than the user.

9. A method, comprising:
executing a videogame;
loading an avatar model based on information received from the videogame, the avatar model including an avatar end-effector and a plurality of avatar nodes;
receiving position information for a user end-effector;
determining, during real time execution of the videogame, a position of an avatar end-effector, wherein the position of the avatar end-effector is calculated using the position information for the user end-effector;
receiving second position information for the user end-effector;
updating, during the real time execution of the videogame, the position of the avatar end-effector to a second position, wherein the position of the avatar end-effector is calculated using the second position information for the user end-effector; and
determining, during the real time execution of the videogame, positions of the avatar nodes to obtain an anatomically possible pose for the avatar model, wherein the pose maintains the updated position of the avatar end-effector.

10. The method of claim 9, further comprising:
capturing, by a camera, an image of a user;
generating a user model that includes the user end-effector; and
determining, from the user model, the position information for the user end-effector.

11. The method of claim 9, wherein the avatar model includes a non-human avatar model.

12. The method of claim 9, further comprising:
setting an orientation of a specific model joint to at least approximate an orientation of a user joint, the orientation of the user joint determined from a generated user model.

13. The method of claim 9, further comprising:
generating an animation stream from the avatar model; and
blending the animation stream with a predefined animation.

14. A computer readable storage medium including processor executable instructions, the computer readable storage medium, comprising:
instructions for generating a user model from an image, wherein the user model includes user end-effectors;
instructions for mapping, during runtime execution of an application, the user end-effectors to an avatar model;
instructions for setting, during runtime execution of an application, positions of avatar joints to obtain an anatomically possible pose for the model; and
instructions for modifying, during runtime execution of the application, the position of the avatar end-effectors and avatar joints based on changes to the user model.

15. The computer readable storage medium of claim 14, wherein the instructions for setting positions of avatar joints further comprise:
instructions for setting an orientation of a specific avatar joint to approximate an orientation of a user joint, the orientation of the user joint obtained from the user model.

16. The computer readable storage medium of claim 14, further comprising:
instructions for generating an animation stream from the avatar model; and
instructions for blending the animation stream with a predefined animation.

17. The computer readable storage medium of claim 14, wherein the instructions for setting positions of avatar joints further comprise:
instructions for determining that a specific avatar joint is unassociated with a specific user joint, wherein a specific avatar joint is unassociated with a specific user joint when the user model does not include position information for the specific user joint; and
instructions for setting a position of the specific avatar joint to a default position.

18. The computer readable storage medium of claim 14, further comprising:
instructions for receiving information that defines a type of avatar used by the application; and
instructions for selecting, during execution of the application, the avatar model from a library of avatar models based on the information that defines a type of avatar used by the application.

19. The computer readable storage medium of claim 14, wherein the instructions for mapping the user end-effectors to an avatar model further comprise:
instructions for resizing interconnects that couple the user end-effectors to joints to fit the size of the avatar model.

20. The computer readable storage medium of claim 14, wherein mapping the user end-effectors to an avatar model further comprise:
instructions for mapping user end-effectors to an avatar model that has a different skeletal architecture than the user model.
